(19) United States
(12) Patent Application Publication
(10) Pub. No.: US 2010/0098464 A1
(43) Pub. Date: Apr. 22, 2010

(54) TONER CARRYING ROLLER, DEVELOPING DEVICE, AND IMAGE FORMING APPARATUS

(75) Inventors: Junichi SUZUKI, Chino (JP); Yoichi YAMADA, Shiojiri (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 12/565,106

(22) Filed: Sep. 23, 2009

(30) Foreign Application Priority Data
Oct. 17, 2008 (JP) 2008-268451
Apr. 15, 2009 (JP) 2009-098956

(51) Int. Cl. G03G 15/08

(52) U.S. Cl. 399/286

(57) ABSTRACT

A toner carrying roller in which a plurality of concave parts are arranged on a surface of a roller base member having a cylindrical shape, includes: an abrasion protection layer formed on the surface of the roller base member; and a charging layer formed on a surface of the abrasion protection layer, the abrasion protection layer being formed in the plurality of concave parts, and mainly made of one of NiP and NiBW.

### BACKGROUND

1. Technical Field

The present invention relates to a toner carrying roller, a developing device, and an image forming apparatus.

2. Related Art

Techniques for developing an electrostatic latent image by toner include a technique in which toner is carried on a surface of a toner carrying roller which is formed to have a nearly cylindrical shape. A toner carrying roller having such a structure is known that convex portions regularly arranged on the surface of the roller, which is formed to have a cylindrical shape, and a concave portion surrounding the convex portions are formed so as to improve a property of the toner carried on the surface of the toner carrying roller, as disclosed in JP-A-2007-127800. Such structure has such an advantage that a thickness and a charging amount of a toner layer carried on the surface of the roller are easily controlled due to evenness of a concaveconvex pattern of the surface which is regulated.

However, in a case where a toner carrying roller having the above structure is used, due to the evenness of the convexconcave, problems such as scattering of the toner from the surface of the toner carrying roller and fogging arise unless a toner film thickness on the toner carrying roller is strictly regulated. It is considered that one of main reasons why these phenomena arise is that old toner is easily carried especially on a layer which is distant from the surface of the toner carrying roller, in a case where the old toner having a property deteriorated as the toner is used is mixed with new toner having a favorable property. The toner layer which is distant from the surface of the toner carrying roller has small adherence with respect to the toner carrying roller, easily causing leak of the toner, scattering, and fogging. The toner carrying roller is required not only to reduce the leak of the toner, the scattering, and the fogging, but also to have high durability.

### SUMMARY

An advantage of the present invention is to provide a toner carrying roller, a developing device, and an image forming apparatus that reduce leak or scattering of toner and fogging, and have high durability.

The inventors were dedicated to studying so as to solve above problems, and obtained the following findings.

In toner particles carried on the surface of the toner carrying roller, new toner particles having a favorable property (hereinafter, referred to as “new toner particles”) aggregate near the surface of the toner carrying roller, while toner particles piling on the new toner particles and carried in a distant manner from the surface of the toner carrying roller include toner particles having a property deteriorated as the toner is used for long periods of time (hereinafter, referred to as “old toner particles”). That is, a first toner layer mainly including the new toner particles is formed on the surface of the toner carrying roller, and a second toner layer mainly including the old toner particles is formed on the first toner layer. These old toner particles have less contact with the toner carrying roller, so that the old toner particles can not obtain sufficient charging, causing leak, scattering, or fogging.

Among the toner layers formed on the surface of the toner carrying roller, a toner layer on convex parts of the toner carrying roller is removed by a regulation member, whereby among toner particles removed from the convex parts, the new toner particles having a large charging amount function to push out the old toner particles, which are carried in a concave part and having a small charging amount and weak adsorption power with respect to the toner carrying roller. As a result, a ratio of the old toner particles included in the toner layer is decreased after regulation, being able to suppress occurrence of toner scattering or fogging.

However, in the above case, there is a new problem that the toner carrying roller is abraded due to the contact of the regulation member to the convex parts and thus durability is degraded. A material having high hardness may be used as a surface covering film for the toner carrying roller. However, the surface is preferably made of a material having a favorable charging property or a material having an anticorrosion property. Thus the material can not be preferentially selected only from an aspect of hardness. The inventors curried out further study so as to solve such the new problem, and completed the present invention.

A toner carrying roller, according to a first aspect of the invention, in which a plurality of concave parts are arranged on a surface of a roller base member having a cylindrical shape, includes: an abrasion protection layer formed on the surface of the roller base member; and a charging layer formed on a surface of the abrasion protection layer, which is formed in the plurality of concave parts, and mainly made of one of NiP and NiBW.

According to the first aspect, the toner can be favorably charged for long periods of time by the charging layer which is mainly made of NiP or NiBW formed in the concave parts. Further, the abrasion protection layer prevents convex parts from being excessively abraded, providing a favorable toner carrying property. Thereby, reliable and high printing quality can be obtained. Accordingly, a toner carrying roller that provides high image quality due to stable toner charge rising and has high durability can be provided.

In the toner carrying roller of the aspect, it is preferable that a thickness of the charging layer be from 0.5 μm to 1.5 μm inclusive.

The use of the charging layer having such thickness can provide a favorable toner charging property.

In the toner carrying roller of the aspect, it is preferable that the abrasion protection layer be mainly made of one of groups of CrC, TiN, TiCN, CrN, TiAlN, TiC, and diamond-like carbon (DLC) and formed thicker than the charging layer.

The abrasion protection layer made of such materials can favorably prevent progress of abrasion of the roller. Further, the film thickness of the charging layer is set to be relatively thin, being able to reduce change of the depth of the concave parts in a case where the charging layer is abraded. Accordingly, effect of the abrasion of the charging layer on a toner carrying property, that is, printing density or the like can be reduced.

In the toner carrying roller of the aspect, it is preferable that the abrasion protection layer be composed of a CrC plated layer in which a part of Cr is crystallized.

The CrC plated layer, on which annealing treatment is performed so as to partially crystallize the layer, has high hardness, and has a more favorable toner charging property than that before the annealing treatment. Therefore, such the CrC plated layer is favorably used as the abrasion protection layer.

A developing device according to a second aspect of the invention includes the toner carrying roller of the first aspect; and a regulation member regulating a toner amount by contacting with a surface of the toner carrying roller.

According to the second aspect, the developing device includes the toner carrying roller that provides high image quality and has high durability as described above, so that the device can provide high image quality due to the stable toner charge rising and has high durability.

An image forming apparatus according to a third aspect of the invention includes the developing device of the second aspect.

According to the third aspect, the image forming apparatus includes the developing device which provides high image quality and has high durability, so that the image forming apparatus also has high durability and provides high quality printing so as to be reliable.

A method for manufacturing a developing device includes: forming a plurality of convex parts and a concave part on a circumferential surface of a roller base member; forming an abrasion protection layer for preventing abrasion of the convex parts and the concave part formed on the circumferential surface; and forming a charging layer for providing a charging property to toner on the abrasion protection layer. The developing device includes: a toner carrying roller that has the plurality of convex parts regularly arranged and a concave part surrounding the convex parts on a surface thereof; and a regulation member that regulates a toner amount by removing the toner on the convex parts by contacting with the surface of the toner carrying roller.

According to the method for manufacturing a developing device, a toner carrying roller covered by an abrasion protection layer and a charging layer and having a concave part and convex parts can be manufactured. In the toner carrying roller manufactured as this, the charging layer covering the convex parts are easily abraded due to the contact with the regulation member, while the charging layer covering the concave part is hardly abraded due to the contact only with the toner. Here, since the toner is removed from the convex parts by the regulation member, the convex parts carry no toner and thus the convex parts need not be covered by the charging layer. Accordingly, the toner carrying roller favorably charge the toner by the charging layer in the concave part for long periods of time even if the charging layer is abraded with time. Further, the abrasion protection layer prevents convex parts from being excessively abraded, providing a favorable toner carrying property. Thereby, reliable and high printing quality can be obtained.

Accordingly, a developing device that provides high image quality due to stable toner charge rising and has high durability can be provided.

In the developing device, it is preferable that the film thickness of the charging layer be set to be thinner than that of the abrasion protection layer.

In such structure, the film thickness of the charging layer is set to be relatively thin, so that change in a height difference between the convex parts and the concave part can be made small when the charging layer covering the convex parts is abraded as described above. Accordingly, an influence on a toner carrying property, that is, an influence on a printing density and the like caused by the abrasion of the charging layer covering the convex parts can be made small.

In the developing device, it is preferable that the abrasion protection layer and the charging layer be formed by plating.

By plating, the abrasion protection layer and the charging layer can be simply and securely formed.

In the developing device, it is preferable that the abrasion protection layer be composed of a CrC plated layer and annealing treatment is performed on the CrC plated layer so as to partially crystallize the CrC plated layer.

In the developing device, it is preferable that the charging layer be composed of a NiBW plated layer and annealing treatment is performed on the NiBW plated layer so as to partially crystallize the NiBW plated layer.

The NiBW plated layer on which the annealing treatment is performed so as to partially crystallize the NiBW plated layer has a favorable toner charging property.

In the developing device, it is preferable that the convex parts and the concave part be formed by performing a rolling treatment on the circumferential surface of the roller base member.

The convex parts and the concave part can be accurately formed on the circumferential surface of the base member by rolling.

### BRIEF DESCRIPTION OF THE DRAWINGS

The invention will be described with reference to the accompanying drawings, wherein like numbers reference like elements.

FIG. 1 is a diagram showing an embodiment of an image forming apparatus to which the invention is applied.

FIG. 2 is a block diagram showing an electrical configuration of the image forming apparatus of FIG. 1.

FIG. 3 is a diagram showing an appearance of a developing device.

FIG. 4 is a sectional view showing a structure of the developing device.

FIG. 5 is a diagram showing a developing roller and a partially enlarged view of a surface of the developing roller.

FIGS. 6A to 6D are diagrams showing a model for explaining a generation mechanism of toner scattering and the like.

FIG. 7 is a graph showing a relationship between a toner particle diameter and adherence to the developing roller.

FIGS. 8A and 8B are diagrams showing a contacting state of the developing roller and a regulation blade.

FIG. 9 is a enlarged schematic view showing a regulation nip.

FIG. 10 is a graph showing distribution of charging amounts of toner measured before and after regulation.

FIG. 11 is a diagram showing an enlarged sectional form of the developing roller.

FIG. 12 is a diagram showing an enlarged sectional form of the developing roller which is temporally abraded.

FIGS. 13A to 13C are schematic views showing a relation between height difference on a surface of the developing roller and carried toner.

FIGS. 14A to 14E are diagrams for explaining a process for manufacturing the developing roller.

FIG. 15 is a diagram for explaining a rolling process for the developing roller.

FIG. 16 is a table showing results of an experiment.

### DESCRIPTION OF EXEMPLARY EMBODIMENT

An embodiment of the invention will be described with reference to the accompanying drawings. A laser beam printer will be first exemplified as an image forming apparatus provided with a developing apparatus according to the invention that is manufactured by a method for manufacturing a developing device, and a structure of the printer will be described.

Image Forming Apparatus

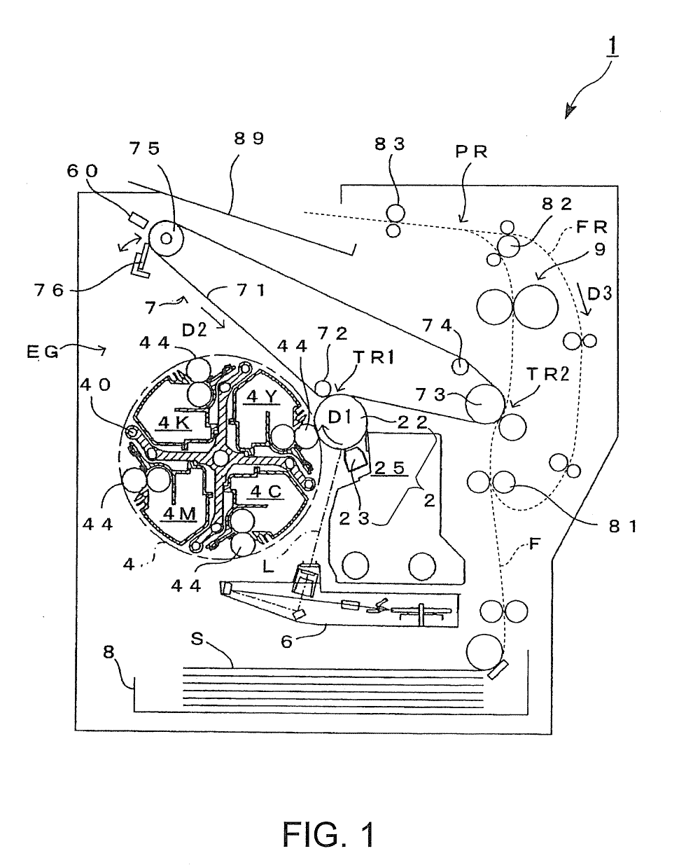

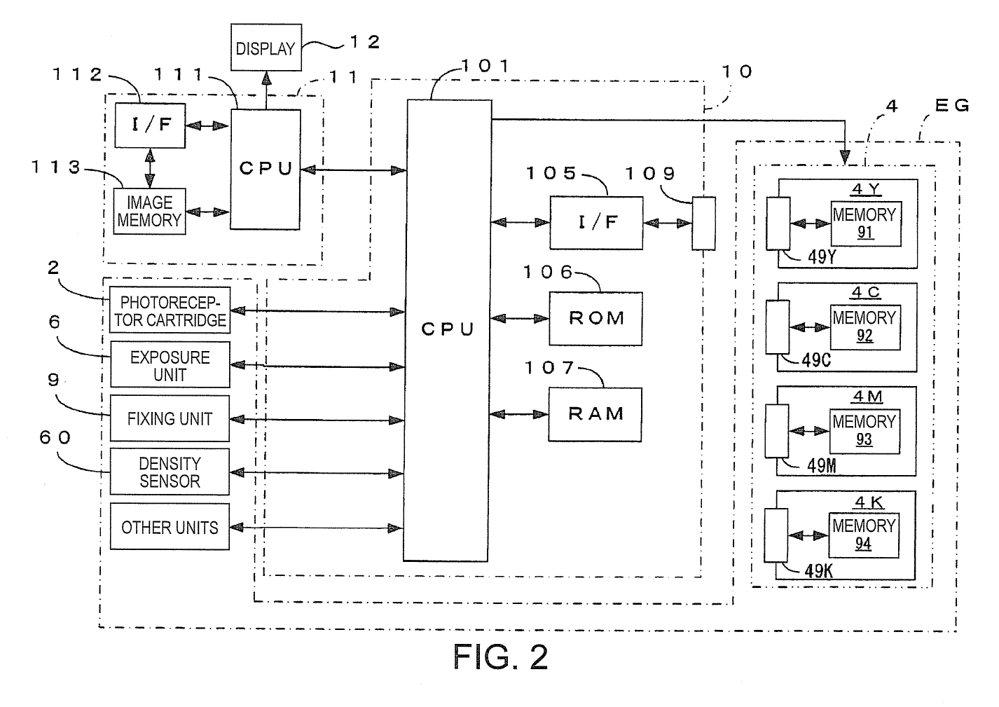

FIG. 1 is a diagram showing an embodiment of an image forming apparatus to which the invention is applied. FIG. 2 is a block diagram showing an electrical configuration of the image forming apparatus of FIG. 1. This image forming apparatus 1 forms a full-color image by superposing four colors, which are yellow (Y), cyan (C), magenta (M), and black (K), of toner (developers) or forms a monochrome image by using only black (K) toner. In the image forming apparatus, when an image signal is given to a main controller 11 from an external device such as a host computer, a CPU 101 provided to an engine controller 10 controls each part of an engine unit EG in accordance with a command from the main controller 11 so as to perform a predetermined image forming operation, thus forming an image corresponding to the image signal on a sheet S.

In the engine unit EG, a photoreceptor 22 is rotably provided so as to rotate in a direction D1 shown by an arrow in FIG. 1. At a circumference of the photoreceptor 22, a charging unit 23, a rotary developing unit 4, and a cleaning part 25 are disposed along the rotating direction D1. To the charging unit 23, a predetermined charging bias is applied, and the charging unit 23 charges a circumferential surface of the photoreceptor 22 at a predetermined surface potential. The cleaning part 25 removes toner residually attached on the surface of the photoreceptor 22 after a primary transfer so as to retrieve the toner in a waste toner tank provided in the inside thereof. The photoreceptor 22, the charging unit 23, and the cleaning part 25 constitute a photoreceptor cartridge 2 in an integrated manner, and the photoreceptor cartridge 2 as a unit is detachable from a body of the apparatus.

The circumferential surface of the photoreceptor 22 which is charged by the charging unit 23 is irradiated with an exposure beam L emitted from an exposure unit 6. The exposure unit 6 exposes the photoreceptor 22 to the exposure beam L in accordance with an image signal received from the external device so as to form an electrostatic latent image corresponding to the image signal.

The electrostatic latent image formed as this is toner-developed by the developing unit 4. In the embodiment, the developing unit 4 includes a support frame 40 provided rotably about a rotation axis which is orthogonal to a plane of FIG. 1; and a yellow developing device (developing apparatus) 4Y, a cyan developing device (developing apparatus) 4C, a magenta developing device (developing apparatus) 4M, and a black developing device (developing apparatus) 4K that are formed as detachable cartridges with respect to the support frame 40 and including toner of respective colors. The developing unit 4 is controlled by the engine controller 10. When the developing unit 4 is rotary-driven by a control command from the engine controller 10 and these developing devices 4Y, 4C, 4M, and 4K are selectively positioned in a manner attaching to the photoreceptor 22 or positioned at predetermined developing positions which are opposed to the photoreceptor 22 with a predetermined gap, a developing roller (toner carrying roller) 44 provided to the developing device and carrying toner of a selected color is positioned opposed to the photoreceptor 22. From the opposed position, the toner is applied to the surface of the photoreceptor 4 from the developing roller (toner carrying roller) 44. Thereby, the electrostatic latent image on the photoreceptor 22 is developed by the toner of the selected color.

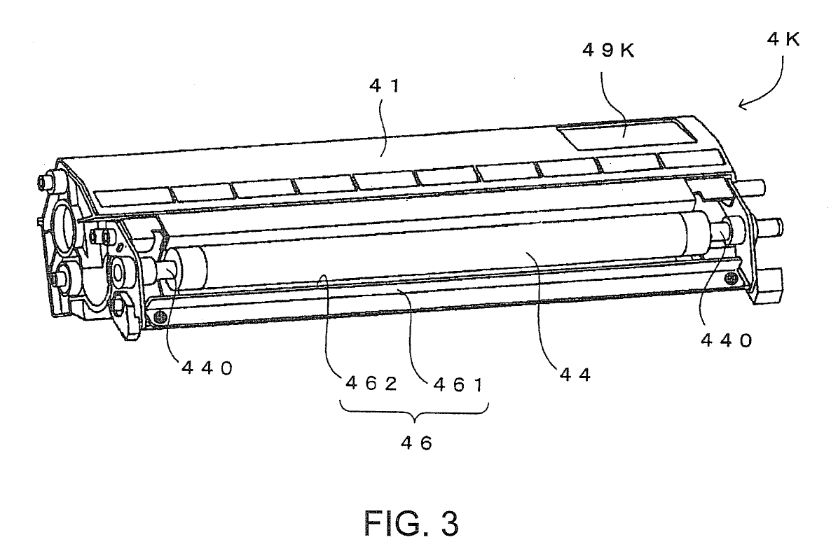

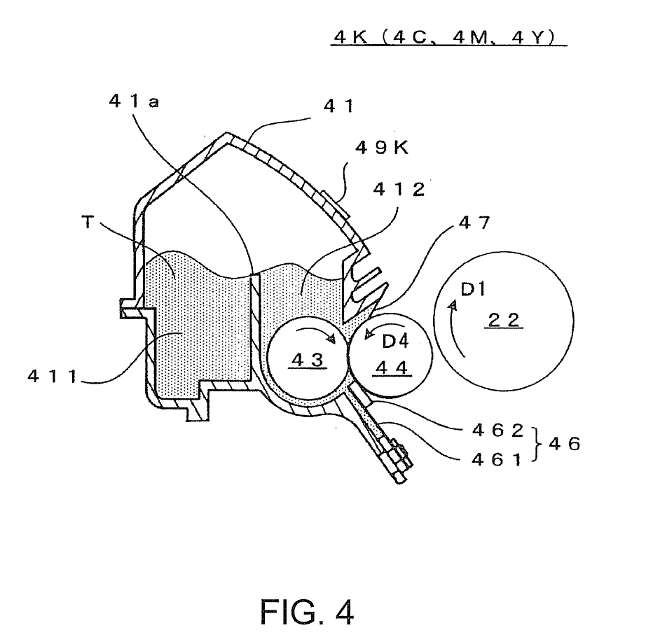

FIG. 3 is a diagram showing an appearance of the developing device. FIG. 4 is a sectional view showing a structure of the developing device. The developing devices 4Y, 4C, 4M, and 4K have the same structures as each other. A structure of the developing device 4K will now be described with reference to FIGS. 3 and 4, but note that the other developing devices 4Y, 4C, and 4M have the same structures as that of the developing device 4K. In the developing device 4K, a supply roller 43 and a developing roller 44 are pivotally supported in a housing 41 which houses the toner T therein. When the developing device 4K is positioned at the developing position, the developing roller 44 is attached to the photoreceptor 22 or is positioned in an opposed manner to the photoreceptor 22 with a predetermined gap, and the rollers 43 and 44 engage with a rotation driving part (not shown) provided to the main body so as to rotate in a predetermined direction. The supply roller 43 is formed to have a cylindrical shape and made of an elastic material such as urethane foam rubber and silicon rubber, for example. The developing roller 44 is composed of a cylindrical base member (roller base member) made of a metal such as copper, aluminum, and stainless steel or an alloy. The developing roller 44 is manufactured by a method for manufacturing a developing device described later, and therefore the developing roller 44 has an excellent toner charging property and durability. When these two rollers 43 and 44 rotate while contacting with each other, the toner is rubbed on a surface of the developing roller 44, thus forming a toner layer with a predetermined thickness on the surface of the developing roller 44. The negatively-charged toner is used in the embodiment, but a positively-charged toner may be used.

An inner space of the housing 41 is separated into a first chamber 411 and a second chamber 412 by a partition 41a. Both of the supply roller 43 and the developing roller 44 are provided in the second chamber 412. By rotation of these rollers 43 and 44, the toner in the second chamber 412 is supplied to the surface of the developing roller 44 while being moved and agitated. On the other hand, the toner stored in the first chamber 411 is segregated from the supply roller 43 and the developing roller 44, so that the toner in the first chamber 411 does not move by the rotation of the rollers. The toner in the first chamber 411 is mixed with the toner stored in the second chamber 412 and agitated when the developing unit 4 rotates in a manner holding the developing device.

Thus, in the developing device, the inside of the housing 41 is separated into two chambers, and the supply roller 43 and the developing roller 44 are surrounded by a lateral wall of the housing 41 and the partition 41a so as to form the second chamber 412 having relatively small bulk. Therefore, even in a case where a remaining amount of the toner is small, the toner is efficiently supplied near the developing roller 44. Toner supply from the first chamber 411 to the second chamber 412 and agitation of the whole toner are performed by the rotation of the developing unit 4, thus realizing an auger-less structure in which no agitating member (auger) for agitating toner is provided inside the developing device.

Further, the developing device 4K includes a regulation blade 46 for regulating the thickness of the toner layer formed on the surface of the developing roller 44 in a predetermined thickness. The regulating blade 46 is composed of a plate member 461 made of stainless steel, phosphor bronze, or the like and having elasticity and an elastic member 462 attached to a fore-end portion of the plate member 461 and made of a resin member such as silicon rubber and urethane rubber. A rear-end portion of the plate member 461 is fixed to the housing 41, and in a rotating direction D4, shown by an arrow in FIG. 4, of the developing roller 44, the elastic member 462 attached to the fore-end portion of the plate member 461 is disposed on an upstream side compared to the rear-end portion of the plate member 461. The elastic member 462 elastically contacts with the surface of the developing roller 44 so as to form a regulation nip, and finally regulates the toner layer formed on the surface of the developing roller 44 in the predetermined thickness.

The toner layer formed on the surface of the developing roller 44 is conveyed in sequence to an opposed position to the photoreceptor 22, which has a surface on which an electrostatic latent image is formed, by the rotation of the developing roller 44. When developing bias is applied to the developing roller 44 from a bias power supply which is not shown, the toner carried on the developing roller 44 attaches to each part of the surface of the photoreceptor 22 in accordance with a surface potential, developing an electrostatic latent image on the photoreceptor 22 as a toner image having the color of the toner.

Further, the housing 41 is provided with a sealing member 47 which is pressed on the surface of the developing roller 44 at a downstream side compared to the opposed position to the photoreceptor 22 in the rotating direction of the developing roller 44. The sealing member 47 introduces the toner remained on the surface of the developing roller 44 which has passed through the opposed position to the photoreceptor 22 to the inside of the housing 41 and prevents the toner in the housing 41 from leaking to the outside.

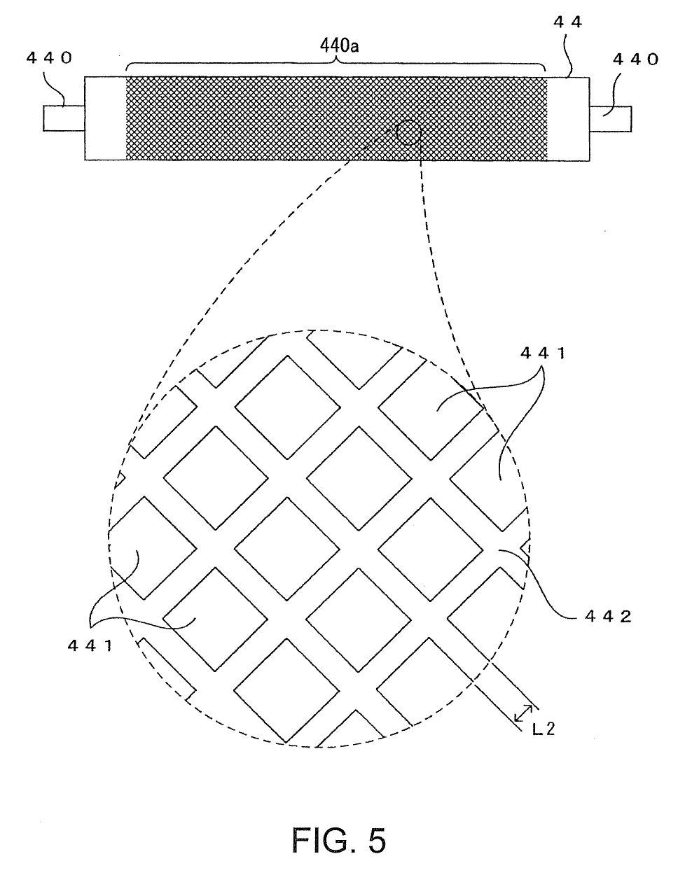

FIG. 5 is a diagram showing the developing roller and a partially enlarged view of the surface of the developing roller. The developing roller 44 is formed to have a nearly cylindrical shape, and a shaft 440 is provided at both ends in the longitudinal direction of the roller 44 in a coaxial manner with the roller. The shaft 440 is pivotally supported by the developing device body and the whole of the developing roller 44 freely rotates. In a center portion 440a of the surface of the developing roller 44, a plurality of convex parts 441 regularly arranged and a concave part 442 surrounding the convex parts 441, as shown in the partially enlarged view (in a dashed-line circle) of FIG. 5.

The plurality of convex parts 441 are protruded toward a front side of a plane of FIG. 5. Each of top surfaces of the convex parts 441 constitutes a part of a single cylindrical surface which is coaxial with the rotating axis of the developing roller 44. The concave part 442 is a continuous groove which surrounds the convex parts 441 in a cancellous manner. The whole of the concave part 442 also constitutes another single cylindrical surface which is coaxial with the rotating axis of the developing roller 44 and is different from the cylindrical surface composed of the convex parts. The developing roller 44 having such the structure can be manufactured by a manufacturing method disclosed in JP-A-2007-140080, for example. Here, the top surfaces of the convex parts 441 can be further processed so as to have flat surfaces.

A distance L2 between the convex parts 441 is approximately from 10 μm to 100 μm, but it is not limited. Also, the shape and the arrangement of the convex parts 441 are not limited to those described in the embodiment. Height difference between the convex parts 441 and the concave part 442 will be described later.

Referring back to FIG. 1, the image forming apparatus will be further described. The toner image developed at the developing unit 4 as described above is primary-transferred on an intermediate transfer belt 71 of a transfer unit 7 in a primary-transfer region TR1. The transfer unit 7 includes the intermediate transfer belt 71 hung across a plurality of rollers 72 through 75, and a driving unit (not shown) which rotary-drives the roller 73 so as to rotate the intermediate transfer belt 71 in a predetermined rotating direction D2. In a case where a color image is transferred to the sheet S, toner images of respective colors formed on the photoreceptor 22 are superposed on the intermediate transfer belt 71 so as to form a color image, and the color image is secondary-transferred on the sheet S which is taken one by one out of a cassette 8 and conveyed to a secondary-transfer region TR2 along a conveyance path F.

Here, timing of feeding the sheet S to the secondary-transfer region TR2 is controlled so as to properly transfer the image of the intermediate transfer belt 71 to a predetermined position. In particular, a gate roller 81 is provided in front of the secondary-transfer region TR2 on the conveyance path F, and the roller 81 rotates in accordance with the timing of revolving of the intermediate transfer belt 71, whereby the sheet S is fed to the secondary-transfer region TR2 at predetermined timing.

On the sheet S, on which the color image has been formed as this, the toner image is fixed by a fixing unit 9, and the sheet S is conveyed to an ejection tray 89 provided on an upper surface of the device body through a roller before ejection 82 and an ejection roller 83. In a case where an image is formed on both surfaces of the sheet S, when a rear-end portion of the sheet S on which an image is formed as above on one surface is conveyed to an invert position PR at the rearward of the roller before ejection 82, the rotating direction of the ejection roller 83 is inverted. Accordingly, the sheet S is conveyed along an invert conveyance path FR in the direction D3 shown by an arrow in the drawing. Then the sheet S is put on the conveyance path F before the gate roller 81. Here, a surface of the sheet S on which an image is transferred by contacting with the intermediate transfer belt 71 in the secondary-transfer region TR2 is an opposite surface to the surface on which the image has been transferred in advance. Thus, the image can be formed on the both surfaces of the sheet S.

Further, as shown in FIG. 2, the developing devices 4Y, 4C, 4M, and 4K respectively include memories 91, 92, 93, and 94 for storing data on a manufacturing lot, use history, a remaining amount of internal toner, and the like. Further, the developing devices 4Y, 4C, 4M, and 4K are respectively provided with radio communication devices 49Y, 49C, 49M, and 49K. These radio communication devices 49Y, 49C, 49M, and 49K selectively perform data communication with a radio communication device 109, which is provided to the main body in a contactless manner, when needed. Thus data is transmitted and received between the CPU 101 and each of the memories 91 to 94 through an interface 105 so as to control various information of control of consumable goods according to the developing device, for example. In the embodiment, data is transmitted and received in a contactless manner by using an electromagnetic means such as radio communication. However, the data may be mutually transmitted and received by mechanically fitting connectors or the like, which are provided to the main body side and each of the developing devices.

As shown in FIG. 2, the apparatus is provided with a display 12 which is controlled by the CPU 111 of the main controller 11. The display 12 is composed of a liquid crystal display, for example, and displays a predetermined message in accordance with a control command of the CPU 111 so as to inform an operation guide, progression state of image forming operation, occurrence of malfunction of the apparatus, time for replacement of any unit, and the like, for users.

Referring to FIG. 2, an image memory 113 is provided to the main controller 11 so as to store an image provided from an external device such as a host computer through an interface 112. A ROM 106 stores control data for controlling calculation program performed by the CPU 101 and controlling the engine part EG, and a RAM 107 temporarily stores a calculation result of the CPU 101 or other data.

A cleaner 76 is disposed near the roller 75. The cleaner 76 can be moved closer to and away from the roller 75 by an electromagnetic clutch which is not shown. The cleaner 76 contacts with the surface of the intermediate transfer belt 71 hung on the roller 75 with its blade in a state that the cleaner is moved to the roller 75 side, so as to remove the toner residually-attached to the circumferential surface of the intermediate transfer belt 71 after the secondary-transfer.

Further, a density sensor 60 is disposed near the roller 75. The density sensor 60 is provided to face the surface of the intermediate transfer belt 71, and measures image density of a toner image formed on the circumferential surface of the intermediate transfer belt 71 when needed. Based on the measurement result, the apparatus adjusts an operation condition, which influences image quality, of each part of the apparatus, such as developing bias given to each of the developing devices, an intensity of the exposure beam L, and a tone correction property of the apparatus.

The density sensor 60 is a reflection-type photosensor, for example, and outputs a signal corresponding to contrasting density in a region having a predetermined area on the intermediate transfer belt 71. Then the CPU 101 periodically takes a sample of an output signal from the density sensor 60 while revolving the intermediate transfer belt 71 so as to detect image density of each part of a toner image on the intermediate transfer belt 71.

Next, regulation of the toner layer formed on the developing roller 44 in the developing device 4K and the like of the image forming apparatus structured as above will be described in detail. As described above, in the developing device 4K and the like of the image forming apparatus, the supply roller 43 contacts with the surface of the developing roller 44 in the housing 41 which stores the toner T, and the regulation blade 46 contacts with the toner layer formed on the developing roller 44 at the downstream side in the rotating direction of the developing roller so as to regulate the thickness of the toner layer carried on the surface of the developing roller 44. Improper thickness of the toner layer adversely affects the image forming operation. That is, if the toner layer is too thin, a conveyance amount of the toner to the opposed position to the photoreceptor 22 is reduced, whereby sufficient image density can not be obtained. On the other hand, if the toner layer is too thick, the toner falls from the surface of the developing roller 44 and leaks inside the apparatus, scatters from the developing roller 44 in a cluster, or attaches to the photoreceptor 22 and causes fogging (these phenomena are generically referred to as “toner scattering and the like”).

Fundamentals of the regulation of the toner layer in the embodiment will be described first. The inventors performed various experimentations on a causal relation between a surface state of the developing roller 44 on which a toner layer was formed and toner scattering and the like in such a manner that the toner layer was set to be relatively thick (about several times as thick as a volume average particle diameter of toner particles). As a result, it became apparent that generating mechanism of the toner scattering and the like could be explained by the following model, for example.

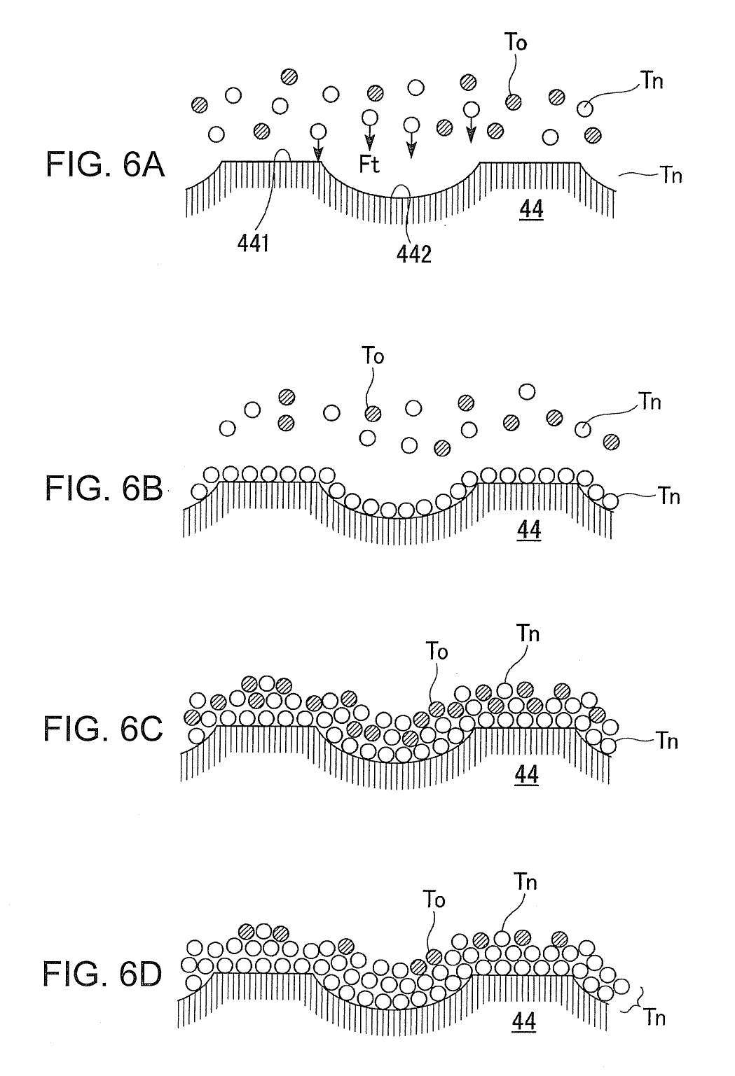

FIGS. 6A to 6D are diagrams showing the model for explaining the generation mechanism of the toner scattering and the like. The developing device is filled with new toner at first. However, as the image forming operation with the developing device is repeated, toner which is fresh and has an original property (referred to as “new toner” in the embodiment) and toner which is used and has a deteriorated property (referred to as “old toner” in the embodiment) are mixed in the developing device. The deteriorated property is brought in such a way that the toner is once carried on the surface of the developing roller 44 but it is not used and returned into the developing device. Therefore, new toner Tn and old toner To are mixed around the developing roller 44 as shown in FIG. 6A. In FIGS. 6A to 6D, white circles denote the new toner Tn, and circles with hatching denote the old toner To.

Among these, the new toner Tn has high fluidity and a high charging amount, so that it is drawn to the surface of the developing roller 44 by electrostatic force Ft. In contrast, the old toner To has poor fluidity and poor charging property due to embedding or peeling off of an external additive, so that drawing force by which the old toner is drawn to the developing roller 44 is smaller than drawing force by which the new toner is drawn. As a result, most toner which directly contacts with the developing roller 44 is the new toner Tn, as shown in FIG. 6B. That is, a first layer proximal to the developing roller 44 among toner layers formed on the surface of the developing roller 44 is formed with the new toner.

On the other hand, layers laminated on the first layer formed as above include the new toner Tn and the old toner To in a mixed manner as shown in FIG. 6C. When the surface of the developing roller 44 is covered by the first layer of the new toner Tn, effect of electrostatic force of the developing roller 44 is weakened on upper layers of the first layer. Therefore, electric charge of the new toner Tn draws other toner particles. As a result, the electric charge draw not only the new toner Tn but also the old toner To which is deteriorated to have a reduced charging amount or takes charge of reverse polarity. In this specification, such a phenomenon that the new toner is concentrated on a layer closest to the surface of the developing roller 44 and the old toner is included in farther layers from the surface of the roller 44 is referred to as a “layer separation phenomenon”.

Here, depending on the electrostatic force of the developing roller 44 or the charging property of the toner, two or more of new toner layers can be formed on the surface of the developing roller 44. In such case as well, in layers apart from the surface of the developing roller 44, the new toner Tn and the old toner To are mixed and the layer separation phenomenon occurs.

Thus, among the toner layers formed on the surface of the developing roller 44, layers at the outer side which are apart from the developing roller 44 include the old toner To at high rate. The old toner To have a low charging amount, so as to have weak adherence to the surface of the developing roller 44 or the toner layers formed on the surface. Accordingly, the old toner To are peeled off from the surface of the developing roller 44 to scatter in the apparatus in the toner conveyance performed by the rotation of the developing roller 44. The toner charged at inversed polarity to original charging polarity attach to a region, to which the toner should not attach, of the electrostatic latent image of the photoreceptor 22, causing fogging.

From the model above, the following experimental facts can be described. For example, when new toner was supplied to a developing device which had been used for long periods of time and had had a small remaining amount of toner, toner scattering and the fogging were temporarily increased and after that the scattering and the fogging were reduced. It seems that this occurred because vicinity of the surface of the developing roller 44 was occupied by the new toner due to the mixing of a large amount of the new toner in the deteriorated toner in the developing device and the outermost surface of the toner layers included large amount of the old toner. When the developing device was further used, the new toner was selectively used and as a result, property difference from the old toner was decreased, so as to alleviate the layer separation phenomenon and therefore decrease a level of the toner scattering and the like as well.

This is confirmed by an experiment in which toner of a different color from that of the original toner is supplied. For example, new yellow toner was supplied to the cyan developing device 4C that had had a small remaining amount of toner, and the surface of the developing roller 44 was observed. As a result, a toner layer having nearly green color obtained by mixing the cyan toner and the yellow toner were formed on the surface of the developing roller. Then, when the toner of the surface was removed by blowing by air or brushing, the color of the surface of the developing roller 44 gradually changed into yellow. Especially, the toner of a first layer which directly contacted with the surface of the developing roller 44 had a yellow color almost same as the original yellow toner color. When the image forming operation was performed with such the developing device, the cyan toner mostly scattered around the developing device or caused fogging on the photoreceptor 22.

Consequently, it is understood that the layer closer to the surface of the developing roller 44 is occupied with the new toner, and the layers apart from the surface include the large amount of the old toner, that is, the layer separation phenomenon arises. Also, it is understood that the toner scattering and the like are mainly caused by the old toner.

Here, the “new toner” and the “old toner” represent relative property difference between toner particles in the developing device, and are not related to whether the toner is new or not. For example, even if toner is new, the toner may have an insufficient property as the old toner to work like the “old toner”. Further, even if the toner is not new, the toner can be regarded as the new toner when relative property difference between toner particles is small.

Such phenomenon arises not only in a structure in which a supply opening for supplying toner is provided to the developing device but also a structure without the opening. For example, in a case where an inside of the developing device is separated into two chambers and the toner is supplied from one chamber to the other chamber at predetermined timing as the present embodiment, the new toner and the old toner are mixed at the supplying timing. The developing device of the embodiment includes no auger, but if the developing device 4K and the like are rotated in accordance with the rotation of the rotary developing unit 4, the new toner stored in the first chamber 411 flows into the second chamber 412, in which the rate of the old toner has been increased, so as to be mixed with the old toner. The mixture occurs in a structure in which a toner conveyance mechanism such as an auger is provided in the developing device, or a structure in which the toner is periodically supplied from a toner tank provided separately from the developing device.

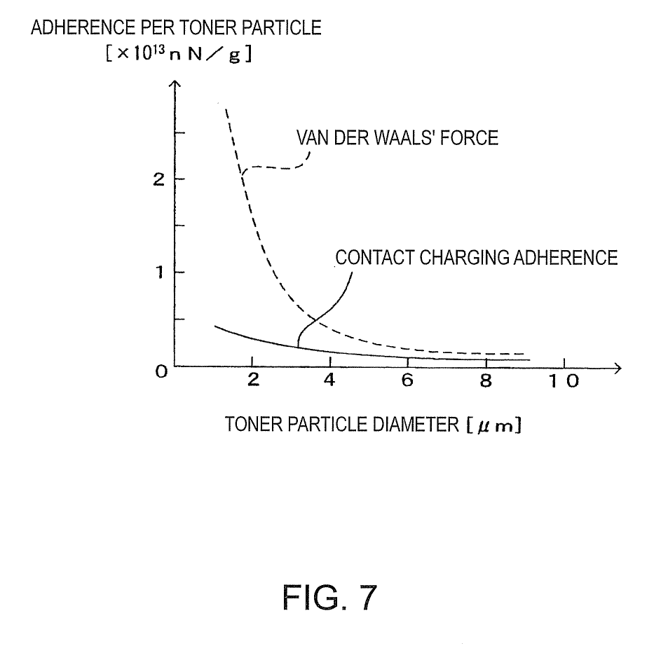

FIG. 7 is a graph showing a relationship between a toner particle diameter and adherence to the developing roller. Contact charging adherence which is electrostatic attracting force working on charged toner and Van der Waals' force are the main force which works to attach toner particles to the surface of the developing roller 44 or a toner layer formed on the surface. As shown in FIG. 7, when the toner particle diameter is large, there is no noticeable difference between an intensity of the contact charging adherence and that of Van der Waals' force. On the other hand, when the toner particle diameter is small, especially, when the diameter is equal to or less than 5 μm, Van der Waals' force is predominant. As Van der Waals' force becomes strong, the toner particles are more easily attached to each other.

In a case where small particle diameter toner on which Van der Waals' force works as above is used, the layer separation phenomenon will especially be a problem. When Van der Waals' force is small, the toner attaches to the surface of the developing roller 44 mainly due to electrostatic attracting force, whereby the old toner having a small charging amount does not concentrate on the surface of the developing roller 44. On the other hand, if Van der Waals' force is strong, more toner attaches to the toner layer on the developing roller 44 regardless of the charging amount. Such toner inevitably includes large amount of the old toner, causing the layer separation phenomenon described above. Further, the old toner particles are aggregated by Van der Waals' force so as to easily form a toner agglomeration. The toner agglomeration has a too small charging amount for its particle diameter, so that the agglomeration easily falls down from the surface of the developing roller 44, causing the toner scattering and the like. As this, the problem caused by the layer separation phenomenon is dominant especially in a case where the particle diameter of the toner T which is used is small.

Therefore, in the embodiment, the toner is not carried by the convex parts 441 of the surface of the developing roller 44 but an evenly-thin toner layer made of the new toner is carried only by the concave part 442. The toner is not carried by the convex parts 441 because of the following reason. If the toner is carried by the convex parts 441, the toner is pressurized by the regulation blade 46 at the regulation nip so as to be aggregated and fixed on the surface of the developing roller 44, sometimes causing a filming phenomenon or scattering of the toner agglomeration to the outside of the developing device. This is noticeable in a case where the old toner is carried by the convex parts 441, and in a case where the toner T has a small particle diameter, that is, the volume average particle diameter is equal to or less than 5 μm as described above. In the present embodiment, the volume average particle diameter of the toner T is about 4.6 μm, for example. In order to avoid such the problem, the toner carried by the convex parts 441 on the surface of the developing roller 44 in the housing 41 is scraped by the regulation blade 46.

The following advantageous effect can be obtained by carrying only by the concave part 442. The toner carried by the concave part 442 is not pressurized or rubbed by the regulation blade 46, thereby being hardly aggregated or deteriorated. This is advantageous in that properties of the toner such as a charging amount and fluidity can be maintained at a state nearly fresh for long periods of time. Thus the production of the “old toner” of which properties are deteriorated is suppressed, being able to further suppress the toner scattering and the like.

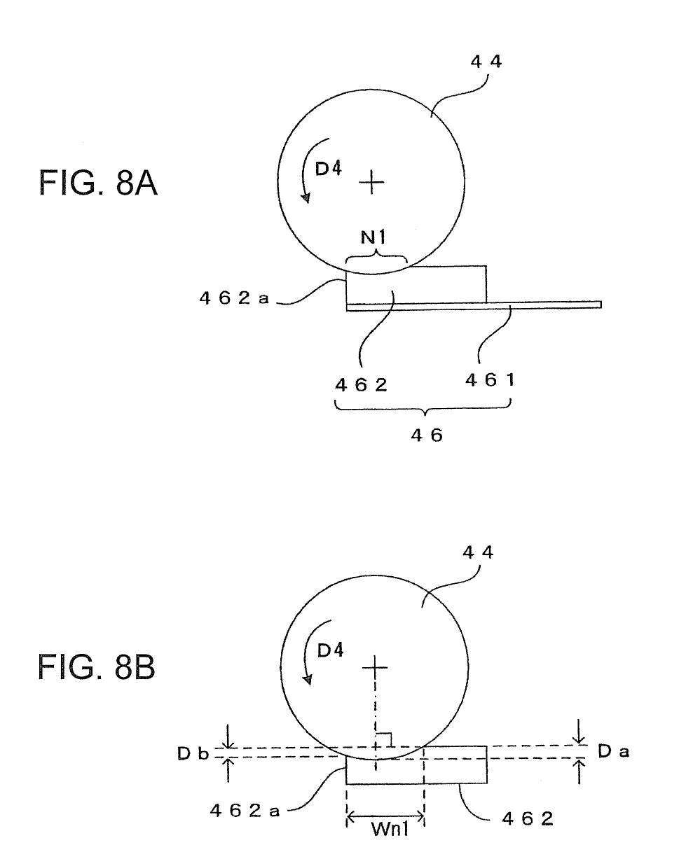

FIGS. 8A and 8B are diagrams showing a contacting state of the developing roller and the regulation blade. In the embodiment, as shown in FIG. 8A, the regulation blade 46 contacts with the surface of the developing roller 44 in a so-called counter direction with respect to the rotating direction D4 of the roller 44, and the elastic member 462 provided to the end portion of the blade 46 is pressed on the surface of the developing roller 44 so as to partially elastically-deform, thus forming a regulation nip N1 at which the surface of the developing roller 44 and the elastic member 462 contact with each other. An upstream side end portion 462a of the elastic member 462 in the rotating direction D4 of the developing roller 44 is included in the regulation nip N1 at its upper edge, regulating the toner by so-called edge regulation.

As shown in FIG. 8B, the upstream side end portion 462a of the elastic member 462 is positioned at an upstream side in the rotating direction D4 of the developing roller 44 compared to a position at a foot of a perpendicular drawn from the rotating center of the developing roller 44 to the upper surface of the elastic member 462. Therefore, a deforming amount Db of the elastic member 462 due to the elastic deformation near the upstream side end portion 462a is slightly smaller than the maximum deforming amount Da of the elastic member 462 near the foot of the perpendicular. Accordingly, the elastic member 462 contacts with the developing roller 44 at a large range on the upper surface thereof, relatively increasing a regulation nip width Wn1.

FIG. 9 is an enlarged schematic view showing the regulation nip of the embodiment. In a region, which is referred to as “before regulation” in FIG. 9, at the upstream side compared to the regulation nip N1 in the rotating direction D4 of the surface of the developing roller 44, a first layer composed of new toner Tn which is shown by while circles is formed directly on the surface of the developing roller 44, while a layer including new toner Tn and old toner To, which is shown by circles with hatching, in a mixed manner is formed on the surface of the first toner layer. On the other hand, in the regulation nip N1, the elastic member 462 of the regulation blade 46 is contacted and pressed on the surface of the developing roller 44, especially on the convex parts 441 of the surface, so that the toner carried by the convex parts 441 before the regulation is scraped by the upstream side end portion 462a of the elastic member 462 regardless of whether the toner is new or old.

The toner scraped from the convex parts 441 includes new toner and old toner in a mixed manner. Especially, the toner removed from the vicinity of the surface of the convex parts 441 has a large charging amount. Most toner attached to the surface of the convex parts 441 is new toner which has an excellent charging property. Further, the charging amount of the new toner is increased due to rubbing by the regulation blade 46 and rolling in the scrape from the convex parts 441, so that strong electrostatic force by which the toner is drawn by the developing roller 44 works. On the other hand, at a rear side (left side in FIG. 9) from the contacting position with the regulation blade 46, old toner which has a small charging amount also exists. When toner particles scraped from the vicinity of the surface of the convex parts 441 and having a large charging amount hit the old toner particles, new toner particles Tn1 and Tn2 having a large charging amount flick old toner particles To1 and To2 having a small charging amount at the rear side. Thus, old toner particles To existing at the vicinity of the surface of the developing roller 44 are gradually replaced to new toner particles Tn so as to be driven to the rear side. Consequently, the toner is carried only by the concave part 442 in the regulation nip N1 and at the downstream side of the regulation nip N1 in the rotating direction D4 of the developing roller, and the ratio of included old toner is substantially low.

In order to promote such the phenomenon, an end surface of the upstream side end portion 462a of the elastic member 462 is preferably formed to be an abrupt wall which is nearly orthogonal to the surface of the developing roller 44. If an angle θ formed by the end portion of the elastic member 462 and the developing roller is a sharp angle, scraped toner is drawn apart from the surface of the developing roller 44, whereby above-mentioned replacement of the old toner by the new toner hardly occurs. If the angle θ is a blunt angle, the scraped toner is pushed into the regulation nip N1 so as to be pressed. When the angle θ is set to be about 90 degrees, the scraped toner stays at the vicinity of the upstream side end portion 462a of the elastic member 462, thus promoting the replacement of the toner particles.

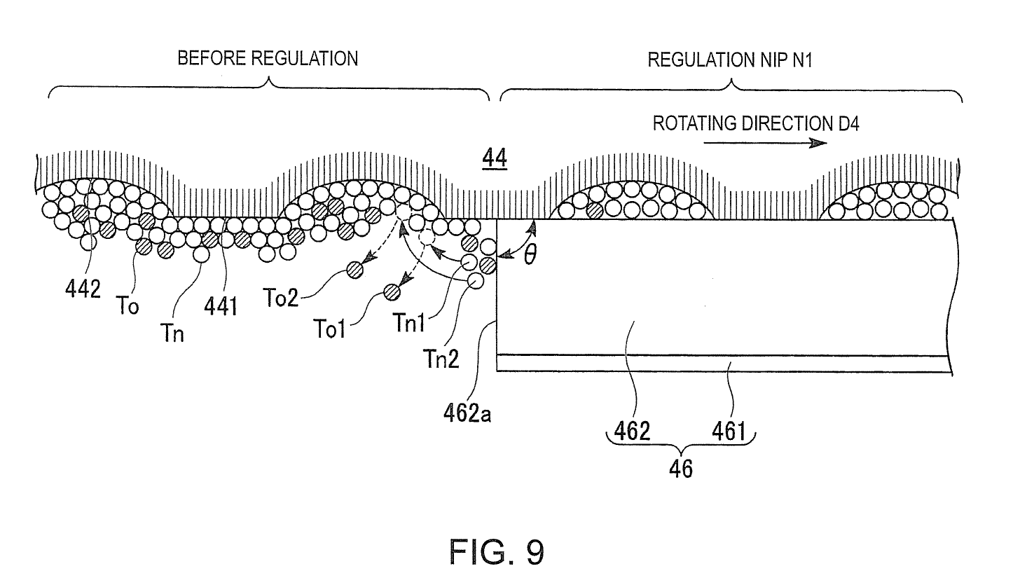

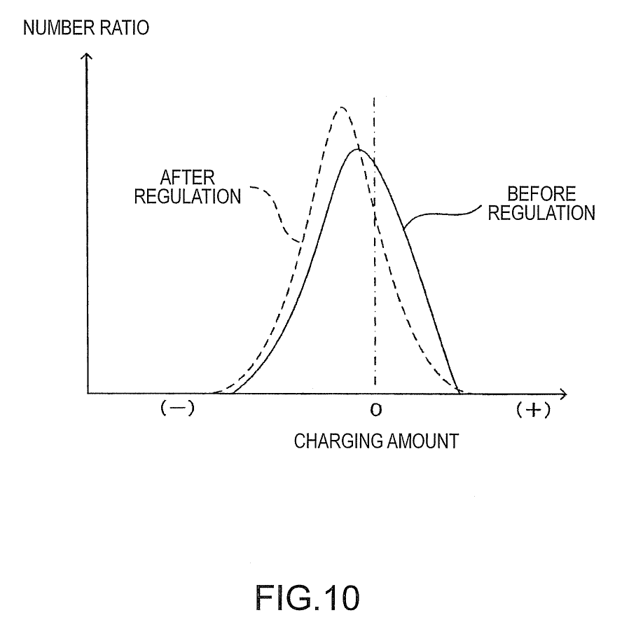

FIG. 10 is a graph showing distribution of charging amounts of toner measured before and after regulation. A bold line in FIG. 10 shows the number ratio in every charging amount of toner particles taken from the surface of the developing roller 44 before regulation by the regulation blade 46. A curve of the bold line is relatively broad and the toner particles include electrically-neutral toner particles and positively-charged toner particles at a high rate. On the other hand, a curve of a dashed line, which shows the number ratio of toner particles taken from the surface of the developing roller 44 after the regulation nip N1, is sharp, and the toner particles after the regulation nip N1 include positively-charged toner particles at a substantially low rate. From this result, it is understood that the toner layer after the regulation is composed of favorably charged toner particles according to the toner regulation of the embodiment. The toner layer which is regulated as above is conveyed to the opposed position to the photoreceptor 22 and an electrostatic latent image is developed, being able to form an excellent image having little fog and preventing old toner particles having a small charging amount from scattering outside the developing device.

Here, height difference between the convex parts 441 and the concave part 442 of the surface of the developing roller 44 will be discussed. In the embodiment, the toner on the convex parts 441 is removed by the contact with the regulation blade 46 and the toner is carried only in the concave part 442. Therefore, an amount of the toner conveyed to the opposed position to the photoreceptor 22 depends on an amount of the toner carried by the concave part 442. Thus the height difference is important for obtaining an excellent image. However, the convex parts 441 may be abraded by the contact with the regulation blade 46 and the amount of the toner carried by the concave part 442 may be changed.

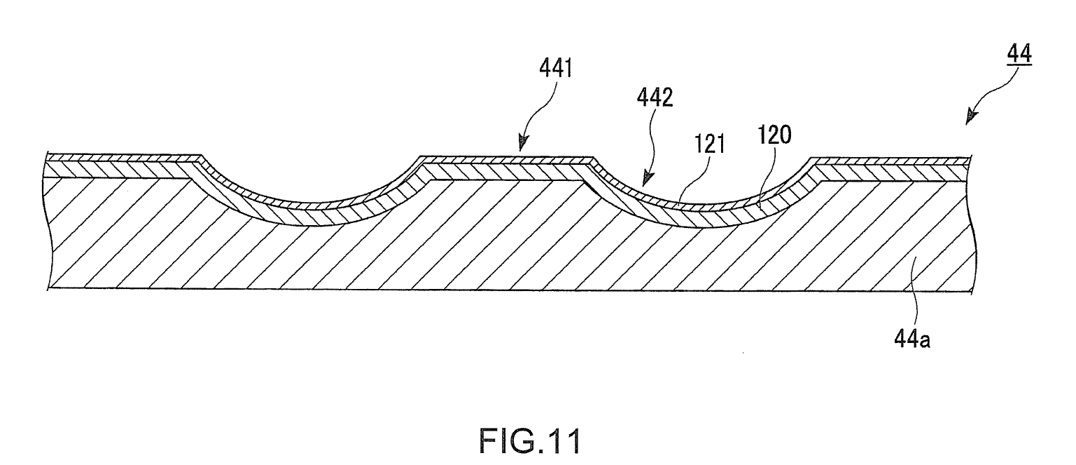

However, the developing roller 44 of the embodiment has an abrasion protection layer 120 formed on a circumferential surface of the base member 44a as shown in FIG. 11. The abrasion protection layer 120 is formed so as to follow a surface shape of the convex parts 441 and the concave part 441 formed on the surface of the base member 44a. The abrasion protection layer 120 is formed so as to prevent abrasion of the convex parts 441 caused by the contact with the regulation blade 46 as described later. The abrasion protection layer 120 is composed of a CrC plated layer and having a thickness of 3 μm, and a part of Cr of the layer 120 is crystallized by an annealing treatment. The abrasion protection layer 120 is very hard such as having hardness equal to or more than 1000HV, so that the layer 120 is not abraded by the contact with the regulation blade 46.

On the abrasion protection layer 120, a charging layer 121 which provides a charging property to the toner is formed. In the embodiment, a NiP plated layer having a thickness of 1 μm is used as the charging layer 121. The charging layer 121 is formed so as to follow a convexconcave shape (convexconcave attributed to the convex parts 441 and the concave part 442) of the abrasion protection layer 120. Hardness of the charging layer 121 is about 550HV.

Here, in the toner regulation of the embodiment, the regulation blade 46 contacts with the convex parts 441, abrading the convex parts 441. On the other hand, the regulation blade 46 does not contact with the concave part 442 and only the toner contacts, so that the inside of the concave part 442 is hardly abraded.

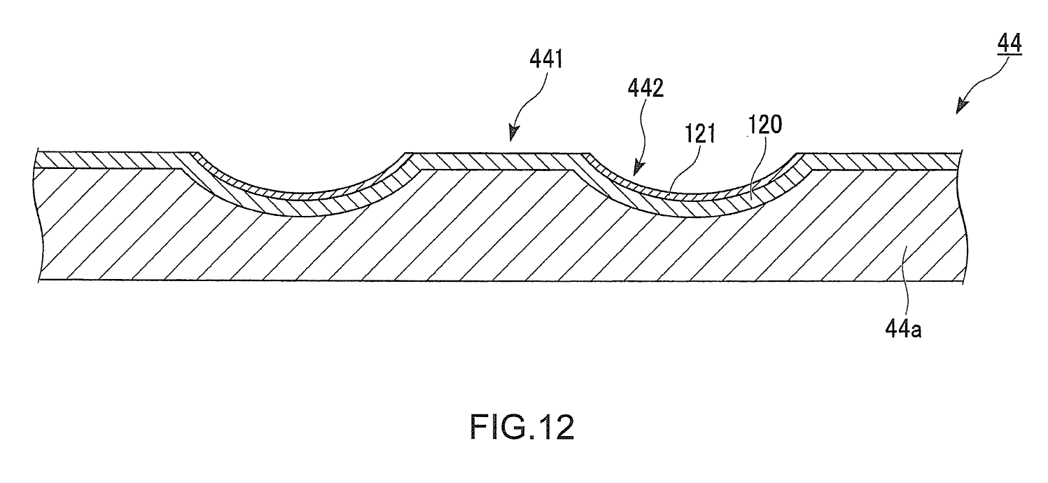

The charging layer 121 formed on the convex parts 441 is abraded by the contact with the regulation blade 46. The abrasion protection layer 120 is exposed on the convex parts 441 with time, as shown in FIG. 12. In the developing roller 44 of the embodiment, the toner is not carried on the convex parts 441. Therefore, even though the charging layer 121 on the convex parts 441 is removed as described above, there is no problem. The abrasion protection layer 120 is very hard as contrasted with the charging layer 121 so as to prevent progress of the abrasion of the developing roller 44 even if the regulation blade 46 contacts with the roller 44. That is, according to the developing roller 44 of the embodiment, the maximum abrasion amount on the convex parts 441 is the thickness (1 μm) of the charging layer 121.

As described above, the film thickness (1 μm) of the charging layer 121 is set to be smaller than the film thickness of the abrasion protection layer 120. Thus, the film thickness of the charging layer 121 is set to be relatively thin, being able to reduce the height difference between the convex parts 441 and the concave part 442 in a case where the charging layer 121 which covers the convex parts 441 is abraded. Accordingly, an influence on a carrying property for the toner, that is, an influence on a printing density and the like caused by the abrasion of the charging layer 121 covering the convex parts 441 can be reduced.

Here, if the charging layer 121 is set to have a thickness less than 0.5 μm, control in the film forming is complicated, and further, sufficient abrasion resistance can not be obtained due to the small film thickness. Consequently, the toner carrying property is decreased due to temporal abrasion and the printing density is adversely affected, whereby the apparatus may obtain insufficient reliability. If the thickness of the charging layer 121 is more than 1.5 μm, the height difference between the convex parts 441 and the concave part 442 largely changes in a case where the charging layer 121 is abraded so as to change the printing density, whereby the apparatus may obtain insufficient reliability. Accordingly, the charging layer 121 is preferably set to have a film thickness from 0.5 μm to 1.5 μm inclusive (the layer 121 has a film thickness of 1.0 μm in the embodiment).

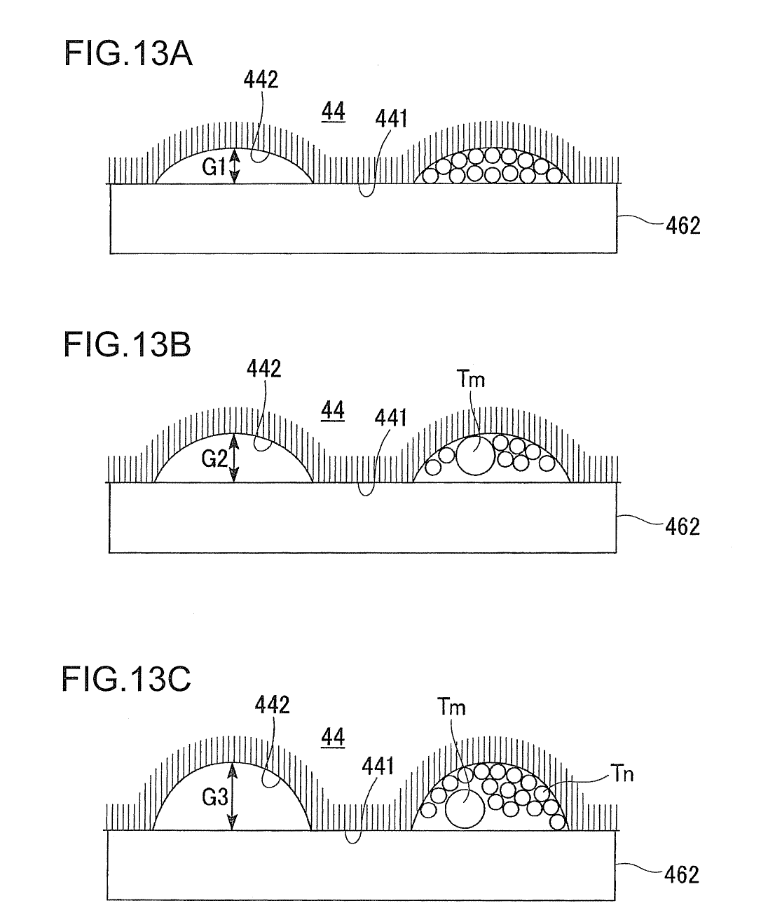

FIGS. 13A to 13C are schematic views showing a relation between the height difference on the surface of the developing roller and carried toner. In the embodiment, in order to carry the toner in the concave part 442 while contacting the elastic member 462 with the convex parts 441, the height difference between the convex parts 441 and the concave part 442, more precisely, an interval between the concave part 442 and the elastic member 462 is set to be equal to or more than a volume average particle diameter of the toner particles. The interval between the concave part 442 and the elastic member 462 in the embodiment corresponds to the developing roller 44 at an initial state (a state that the charging layer 121 on the convex parts 441 is not abraded). Hereinafter, the volume average particle diameter of the toner particles is denoted by Dave. Here, as shown in FIG. 13A, when the interval between the concave part 442 and the elastic member 462 is set to have a value G1 which is more than a double of the volume average particle diameter Dave of the toner particles, toner particles for two layers or more are averagely carried in the concave part 442.

The toner particles in a first layer which contacts with the surface of the developing roller 44 attach to the developing roller 44 with a large electrostatic force, but the toner particles in a second layer and subsequent layers which are on the first layer attach with a smaller electrostatic force so as to be easily detached from the developing roller 44. Therefore, the toner particles in the second and subsequent layers assume an important role in developing an electrostatic latent image at the opposed position to the photoreceptor 22. That is, developing efficiency can be improved by forming the second and subsequent toner layers in the concave part 442 compared to a case where a single toner layer is carried. This is especially efficient in a case of using toner having a small particle diameter (a volume average particle diameter is 5 μm or less, for example) by which adherence between the toner particles is increased due to Van der Waals' force. From this point, the interval between the concave part 442 and the elastic member 462 is preferably set to be equal to or more than a double of the volume average particle diameter Dave of the toner particles. However, if the interval is set to be too large, old toner particles are allowed to be mixed, whereby the interval is preferably equal to or less than a triple of the volume average particle diameter Dave of the toner particles. That is, the interval is preferably set so as to satisfy the following equation.

Dave≦G1≦3Dave Equation 1

The interval is preferably set especially in a case where toner having small variety of particle diameters is used.

As shown in FIG. 13B, in consideration of variety of particle diameters of the toner particles, an interval G2 between the concave part 442 and the elastic member 46 may be set to be equal to or more than a particle diameter of a maximum particle diameter toner particle Tm having the maximum particle diameter in the toner T. Here, the maximum particle diameter of toner particles can be statistically set as follows. That is, the maximum particle diameter Dm can be defined by the following equation, when a 50% particle diameter based on the number of the toner particles of the toner T is denoted by D50 and a geometric standard deviation is denoted by σ.

Dm=D50+3σ Equation 2

Toner commonly used seldom has a particle diameter more than the maximum particle diameter Dm.

If the interval between the concave part 442 and the elastic member 462 is small and a toner particle having a large particle diameter enters the concave part 442, the particle is pressed by the elastic member 462 so as to be deteriorated. Further, toner particles having a large particle diameter stay in the developing device without being taken in the concave part 442, so that a particle diameter distribution of the toner particles in the developing device shifts to a large particle diameter side, making the toner unsuitable for developing. On the other hand, when the interval between the concave part 442 and the elastic member 462 is set to be equal to or more than the maximum particle diameter Dm as described above, almost all the toner particles included in the toner T which is stored in the developing device can be carried. Thus the toner in the developing device can be efficiently used up. That is, the interval is preferably set so as to satisfy the following equation.

G2≧Dm=D50+3σ Equation 3

As shown in FIG. 13C, the maximum particle diameter toner particle Tm can be carried on the first layer of the toner layers carried by the concave part 442. An interval G3 between the concave part 442 and the elastic member 462 may be set so as to satisfy the following equation.

G3≧Dave+Dm=Dave+D50+3σ Equation 4

Accordingly, even the maximum particle diameter toner particle Tm can be carried on the toner layer which contact with the developing roller 44, so that toner having a large particle diameter can be more efficiently used for developing.

As described above, in the embodiment, the toner carried by the convex parts 441 of the surface of the developing roller 44 is scraped by the regulation blade 46 at the regulation nip N1 and the toner is carried only by the concave part 442. Thus, the toner is prevented from being pressed in the regulation nip N1 so as to be prevented from being aggregated or deteriorated. The prevention of the deterioration of the toner can reduce the scattering, mainly caused by deteriorated toner, of the toner to the outside of the developing device from the developing roller 44. The upstream side end surface of the regulation blade 46 is formed to be an abrupt wall which is nearly orthogonal to the surface of the developing roller 44 so as to retain scraped toner. Thereby, old toner entering in the concave part 442 is replaced by new toner so as to reduce a ratio of the old toner included in the toner layer. Accordingly, the amount of the old toner conveyed to the outside of the developing device, further improving suppression effect of the toner scattering and fogging.

The developing roller 44 can suitably charge the toner inside the concave part 442 by the charging layer 121, and prevent the convex parts 441 from being excessively abraded by the abrasion protection layer 120, so that a favorable toner carrying property can be maintained and a high printing quality can be obtained.

Accordingly, the image forming apparatus 1 of the embodiment provides high image quality and high durability due to a stable charge rising property of the toner.

Method for Manufacturing Developing Device

A process for manufacturing the developing device 4M will be described as an example of a method for manufacturing a developing device according to the embodiment. A manufacturing process of the developing roller 44, among components of the developing device 4M, is characteristic, so that the process for manufacturing the developing roller 44 will be mainly described and descriptions of other components will be omitted or simplified.

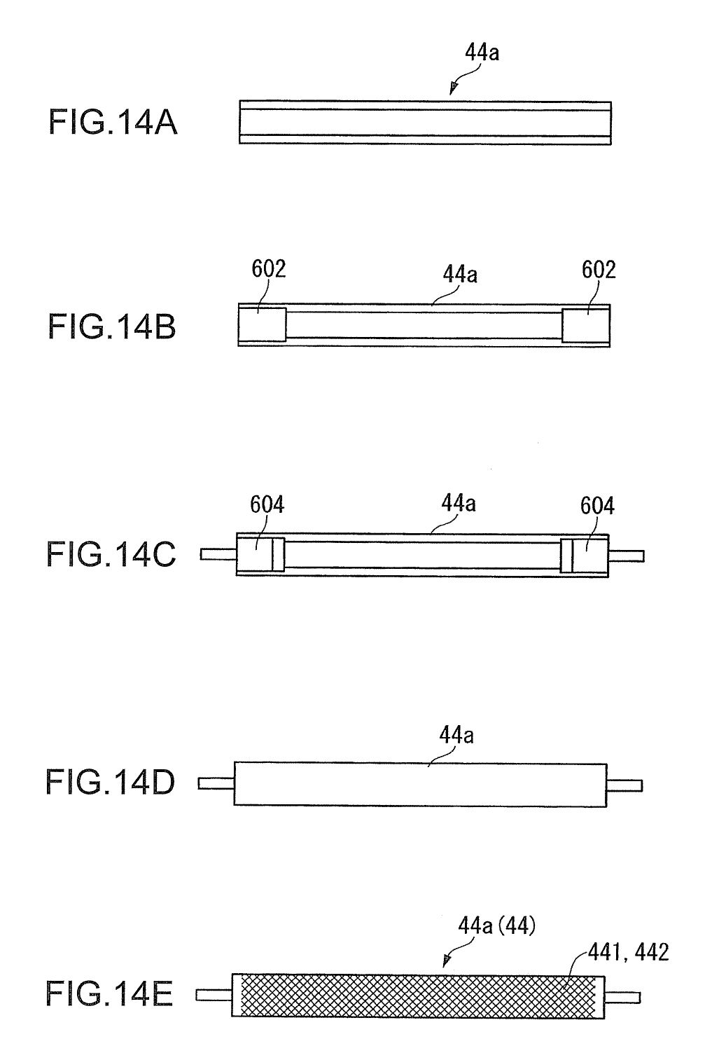

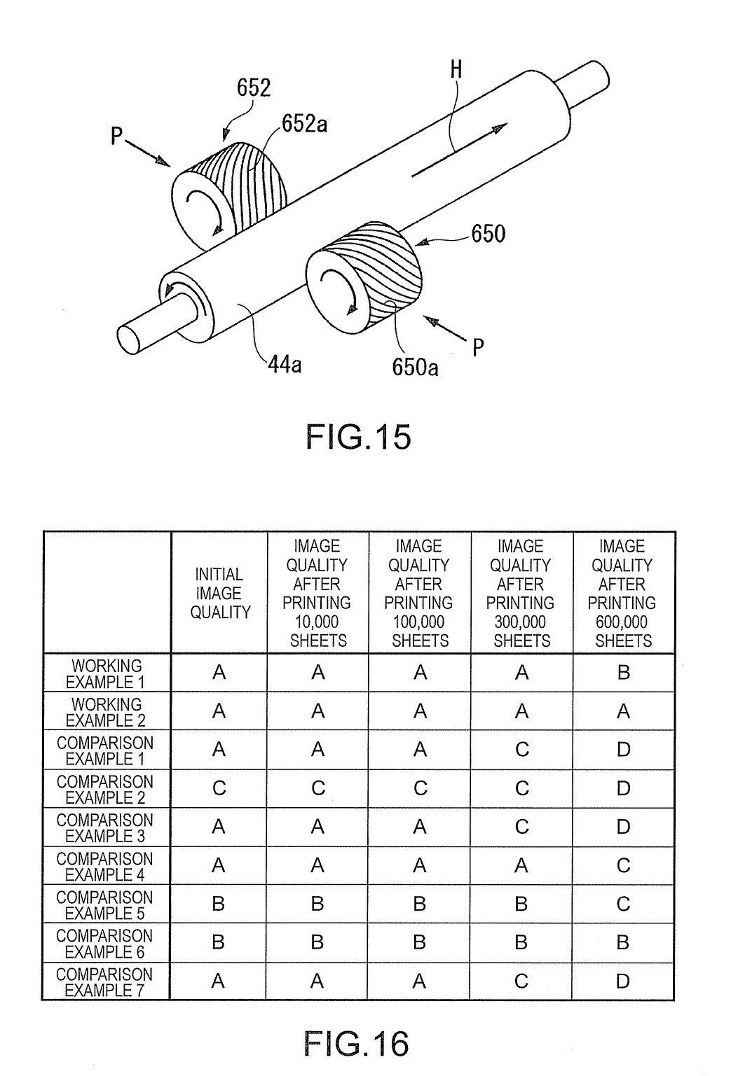

FIGS. 14A to 14E are schematic views showing transition of the developing roller 44 in the process for manufacturing the developing roller 44. FIG. 15 is an explanatory diagram for explaining a rolling process of the developing roller 44.

As shown in FIG. 14A, the base member 44a, having a pipe shape, for the developing roller 44 is prepared. The wall thickness of the base member 44a is from 0.5 mm to 3 mm, for example. Then, as shown in FIG. 14B, flange press fitting parts 602 are formed on both end portions, which are positioned in a longitudinal direction, of the base member 44a. These flange press fitting parts 602 are formed by cutting. As shown in FIG. 14C, flanges 604 are pressed into the flange press fitting portions 602. In order to securely fix the flanges 604 to a pipe member 600, the flanges 604 may be bonded or welded to the pipe member 600 after the flanges 604 are pressed into the flange press fitting portions 602.

As shown in FIG. 14D, centerless-polishing is performed on a surface of the base member 44a into which the flanges 604 are pressed. The centerless-polishing is performed on the whole of the surface, and a ten-point average roughness of the surface after the centerless-polishing is set to be equal to or less than 1.0 μm, for example.

As shown in FIG. 14E, a rolling process is performed on the base member 44a into which the flanges 604 are pressed. In the embodiment, so-called throughfeed rolling (also called walk rolling or through rolling) using two round dies 650 and 652 is performed.

That is, as shown in FIG. 15, the two round dies 650 and 652 which are disposed so as to sandwich the base member 44a as a work are rotated in the same direction (refer to FIG. 15) while pressing the round dies 650 and 652 to the base member 44a at a predetermined pressure (FIG. 15 shows a direction of the pressure by a symbol P). In the throughfeed rolling, according to the rotation of the round dies 650 and 652, the pipe member 600 moves in a direction shown by H in FIG. 15 while rotating in an inverted direction to the rotation direction of the round dies 650 and 652. On surfaces of the round dies 650 and 652, convex parts 650a and 652a are provided so as to form grooves 680. These convex parts 650a and 652a deform the base member 44a, thus forming the convex parts 441 and the concave part 442 as shown in FIG. 14E.

Then, a CrC plated layer having a film thickness of 3 μm is formed on a surface (circumferential surface) of a center part 510a by electro plating after the rolling process. After the CrC plated layer is formed, an annealing process (300° C., 1 hour) is performed. Thereby, the CrC plated layer is gradually crystallized from an amorphous state, and finally the abrasion protection layer 120 having the crystallized part is formed. Here, the abrasion protection layer 120 is formed so as to follow the convexconcave shape of the base member 44a.

Subsequently, a NiP plated layer having a film thickness of 1 μm is formed on the abrasion protection layer 120 by electroless plating, thus forming the charging layer 121. Here, the charging layer 121 is formed so as to follow the convexconcave shape of the base member 44a.

Through the above described process, the developing roller 44 is manufactured.

The developing roller 44 manufactured as above and the regulation blade 46 manufactured in another process are attached to the housing 41, completing the assemble of the developing device 4M.

### Modification

A modification of the invention will be described. In the modification, a material of a charging layer which is formed on a circumferential surface of the developing roller is different from that in the embodiment, while other structures are common to those of the embodiment. Therefore, descriptions except for descriptions of a structure of the developing roller and a method for manufacturing a developing roller will be omitted.

A developing roller according to the modification is composed of a NiBW plated layer having a film thickness of 1 μm as the charging layer 121. As is the case with the embodiment, a CrC plated layer having a film thickness of 3 μm is formed as the abrasion protection layer 120. In the modification, the charging layer 121 and the abrasion protection layer 120 are formed to be such a state that Cr and Ni are partially crystallized by annealing.

Accordingly, progress of abrasion of the developing roller 44 is prevented by the abrasion protection layer 120, whereby the developing roller of the modification also has excellent durability.

In order to manufacture the developing roller according to the modification, the convex parts 441 and the concave part 442 are formed on the base member 44a as is the case with the above embodiment (refer to FIGS. 14A to 14E). Subsequently, the CrC plated layer having a film thickness of 3 μm is formed on the circumferential surface of the base member 44a by electro plating.

Then, the NiBW plated layer having a film thickness of 1 μm is formed on the CrC plated layer by electroless plating. Here, the NiBW plated layer is formed so as to follow the convexconcave shape of the base member 44a.

After the CrC plated layer and the NiBW plated layer are laminated on the circumferential surface of the base member 44a, an annealing treatment (300° C., 1 hour) is performed. Thereby, the CrC plated layer and the NiBW plated layer are gradually crystallized from the amorphous state, and finally part of them is crystallized. That is, the abrasion protection layer 120 and the charging layer 121 are formed by partially crystallizing Cr and Ni. Thus, plated layers (the CrC plated layer and the NiBW plated layer) constituting the abrasion protection layer 120 and the charging layer 121 are annealed at a time in the modification. Through the above process, the developing roller according to the modification can be manufactured.

Note that the present invention is not limited to the above embodiment, but can be applied to various modifications without departing from the scope of the invention. For example, TiN, TiCN, CrN, TiAlN, TiC, and DLC (diamond-like carbon) may be used instead of the CrC plated layer as the abrasion protection layer. Such abrasion protection layer can be formed by vapor depositing, plating, DIP, or the like.

### Experimental Example

Initial image quality, image quality after printing 10,000 sheets, image quality after printing 100,000 sheets, image quality after printing 300,000 sheets, and image quality after printing 600,000 sheets were measured by performing printing by an image forming apparatus provided with a developing roller of which a circumferential surface was covered by various plates. Thereby, whether density unevenness arose or not was checked, and thus temporal deterioration of the image qualities, that is, printing durability was checked. A table of FIG. 16 shows obtained results. Here, the developing roller 44 of the above embodiment was used in a working example 1, and the developing roller of the above modification was used in a working example 2.

For comparison, an image forming apparatus provided with a developing roller in which only a NiP plated layer (3 μm) was formed on a circumferential surface of a base member, on which convex parts and a concave part had been formed by rolling, was used as a comparison example 1.

An image forming apparatus provided with a developing roller in which a NiP plated layer (3 μm) was formed on a circumferential surface of a base member, on which convex parts and a concave part had been formed by rolling, and then an annealing treatment (300° C., 1 hour) was performed was used as a comparison example 2.

An image forming apparatus provided with a developing roller in which only a NiBW plated layer (3 μm) was formed on a circumferential surface of a base member, on which convex parts and a concave part had been formed by rolling, was used as a comparison example 3.

An image forming apparatus provided with a developing roller in which a NiBW plated layer (3 μm) was formed on a circumferential surface of a base member, on which convex parts and a concave part had been formed by rolling, and then an annealing treatment (300° C., 1 hour) was performed was used as a comparison example 4.

An image forming apparatus provided with a developing roller in which only a CrC plated layer (3 μm) was formed on a circumferential surface of a base member, on which convex parts and a concave part had been formed by rolling, was used as a comparison example 5.

An image forming apparatus provided with a developing roller in which a CrC plated layer (3 μm) was formed on a circumferential surface of a base member, on which convex parts and a concave part had been formed by rolling, and then an annealing treatment (300° C., 1 hour) was performed was used as a comparison example 6.

An image forming apparatus provided with a developing roller in which a CrC plated layer (3 μm) was formed on a circumferential surface of a base member, on which convex parts and a concave part had been formed by rolling; an annealing treatment (300° C., 1 hour) was performed; and then a NiP plated layer (3 μm) was formed on the abrasion protection layer was used as a comparison example 7.

Printing durability of the comparison examples 1 to 7 was checked as is the case with the working examples 1 and 2. Obtained results are shown in the table of FIG. 16.

The table of FIG. 16 shows four levels of judgments corresponding to density unevenness. “A” of the table of FIG. 16 indicates that there is no density unevenness, that is, high image-quality can be obtained. “B” of the table of FIG. 16 indicates that there is some density unevenness (at a level on which there is no problem in practical use). “C” in the table of FIG. 16 indicates that the density unevenness is distinguished and adversely effects image quality (low image-quality). “D” of the table of FIG. 16 indicates image quality defect (experimental disapproving).

As shown in the table of FIG. 16, the image developing apparatuses of the working examples 1 and 2 exhibited excellent printing even after printing 600,000 sheets. Thus, it was recognized that their developing rollers had very high durability.

From the comparison example 1 in which only the NiP plated layer was formed, it was verified that density unevenness was distinguished and preferable printing could not be obtained after the printing of 300,000 or more sheets.

From the comparison example 2, it was verified that hardness of the NiP plate was improved by the annealing treatment and durability as a roller was improved, but a toner charging property was substantially decreased and preferable printing could not be obtained in the initial image quality, in this case.

From the comparison example 3 in which only the NiBW plated layer was formed, it was verified that density unevenness was distinguished and preferable printing could not be obtained after the printing of 300,000 or more sheets.

From the comparison example 4, it was verified that a favorable toner charging property and favorable printing up to 300,000 sheets could be obtained due to the annealing treatment performed on NiBW, though they were inferior to the working examples 1 and 2.

From the comparison examples 5 and 6 respectively in which the CrC plated layer was formed and in which the CrC plated layer was formed and the annealing treatment was performed, it was verified that though abrasion of the convex parts were prevented, a toner charging property was inferior and favorable printing could not be obtained.

From the comparison example 7 in which the NiP layer was formed to have large film thickness (3 μm) on the CrC plated layer, on which the annealing treatment had been performed, it was verified that favorable printing could be obtained up to 100,000 sheets as is the case with the working examples, but durability was substantially inferior. That is, as shown in the working example 1, it was confirmed that forming the NiP plated layer functioning as a charging layer thinly is necessary for achieving a good balance between a favorable toner charging property and durability.

The entire disclosure of Japanese Patent Application Nos. 2008-268451, filed Oct. 17, 2008 and 2009-098956, filed Apr. 15, 2009 are expressly incorporated by reference herein.

What is claimed is:

1. A toner carrying roller in which a plurality of concave parts are arranged on a surface of a roller base member having a cylindrical shape, comprising:
an abrasion protection layer formed on the surface of the roller base member; and
a charging layer formed on a surface of the abrasion protection layer, the abrasion protection layer being formed in the plurality of concave parts, and mainly made of one of NiP and NiBW.

2. The toner carrying roller according to claim 1, wherein a thickness of the charging layer is from 0.5 μm to 1.5 μm inclusive.

3. The toner carrying roller according to claim 1, wherein the abrasion protection layer is mainly made of one of groups of CrC, TiN, TiCN, CrN, TiAlN, TiC, and diamond-like carbon (DLC) and formed thicker than the charging layer.

4. The toner carrying roller according to claim 3, wherein the abrasion protection layer is composed of a CrC plated layer in which a part of Cr is crystallized.

5. A developing device, comprising: the toner carrying roller of claim 1; and a regulation member regulating a toner amount by contacting with a surface of the toner carrying roller.

6. An image forming apparatus, comprising the developing device of claim 5.
